(19) United States
(12) Patent Application Publication
(10) Pub. No.: US 2017/0004426 A1
(43) Pub. Date: Jan. 5, 2017

(54) USER INTERFACE-PROVIDING METHOD, SERVER, AND COMPUTER-READABLE RECORDING MEDIUM FOR RECORDING AND MANAGING INFORMATION RELATED TO ORGANIZATION

(71) Applicant: Woojae Kim, Seoul (KR)

(72) Inventor: Woojae Kim, Seoul (KR)

(21) Appl. No.: 15/106,001

(22) PCT Filed: Dec. 22, 2014
(86) PCT No.: PCT/KR2014/012651

§ 371 Date: Jun. 17, 2016

(30) Foreign Application Priority Data
Dec. 20, 2013 (KR) 10-2013-0160562

(51) Int. Cl. G06Q 10/06

(52) U.S. Cl. CPC G06Q 10/0639

(57) ABSTRACT

A method for providing user interface to manage a user's information is disclosed. The method includes steps of: providing a baseline including a meaning of time series; acquiring information on start points of time or end points of time regarding new histories or new goals if the new histories or the new goals are inputted by the user; displaying one or more main areas for indicating existence of main information to indicate that one or more contents related to the histories or the goals have been inputted at one or more positions on the baseline or around the one or more positions, wherein the one or more positions are determined to correspond to the acquired one or more pieces of information on the start points of time or the end points of time.

### FIELD OF THE INVENTION

The present invention relates to a method, a server, and a computer-readable medium for providing user interface (UI) for recording and managing information on a specific organization; and more particularly, to the method, the server, and the computer-readable medium for providing the UI for allowing information on histories of the specific organization to be visually recognized at a glance and be effectively indicated by acquiring information on start points of time or end points of time related to one or more new histories or one or more new goals of the specific organization inputted by a manager corresponding to the specific organization, and displaying one or more main areas for indicating existence of main information to indicate that one or more contents related to the one or more histories or the one or more goals at one or more positions on a baseline or around the one or more positions, wherein the one or more positions are determined to correspond to the acquired one or more pieces of information on the start points of time or the end points of time.

### BACKGROUND OF THE INVENTION

In general, to hire employees, a company follows procedures for posting a job opening at its website, etc., receiving resumes from many job applicants through the website, etc., reviewing them, having person-to-person interviews according to the review result and then finally hiring employees it wants to employ.

For example, the Korean Patent Laid-Open Publication No. 10-2012-0138494 suggests “an apparatus and a method for managing resumes by using SNS authentication” which discloses an apparatus and a method for providing resumes with more reliable information to companies.

But the problem was that, while companies can get resumes which contain applicants' personal histories easily, it is difficult for the applicants to get information on characteristics of the companies and to determine a specific company fit for themselves among a lot of companies, even though it is important for them to obtain information on the companies which they will apply to or work for in the future.

Besides, the other problem was that it is not easy for a company which intends to take over or acquire other company or a third person who needs to consult a company to obtain information thereon.

### SUMMARY OF THE INVENTION

It is an object of the present invention to solve all the aforementioned problems.

It is another object of the present invention to clearly identify general history matters of an organization at a glance by visually displaying a baseline including a meaning of time series, main areas for indicating existence of main information, etc. to indicate the history matters of the organization.

It is still another object of the present invention to prevent goal(s) of the organization from being deleted by preventing an authority to delete the already inputted goal(s) from being provided to a manager corresponding to the organization.

It is still yet another object of the present invention to improve reliability of the information on the organization by allowing contents by which the history(s) or goal(s) of the organization is proved to be attached.

In accordance with one aspect of the present invention, there is provided a method for providing user interface to record and manage information on an organization, including steps of: (a) providing a baseline including a meaning of time series; (b) acquiring one or more pieces of information on start points of time or end points of time regarding one or more new histories or one or more new goals of the organization if the one or more new histories or the one or more new goals are inputted by a manager corresponding to the organization; (c) displaying one or more main areas for indicating existence of main information to indicate that one or more contents related to the one or more histories or the one or more goals have been inputted at one or more positions on the baseline or around the one, or more positions, wherein the one or more positions are determined to correspond to the acquired one or more pieces of information on the start points of time or the end points of time.

In accordance with another aspect of the present invention, there is provided a server for providing user interface to record and manage information on an organization to a user terminal, including: a template providing part for providing a template for displaying a baseline including a meaning of time series and displaying one or more main areas for indicating existence of main information to indicate that one or more contents regarding one or more new histories or one or more new goals of the organization are inputted by a manager of or in relation to the organization, wherein the main areas are displayed by referring to the baseline; a time cue acquiring part for acquiring one or more pieces of information on start points of time or end points of time regarding one or more new histories or one or more new goals of the organization inputted by the manager; and an organization information exposing part for displaying the one or more main areas for indicating existence of main information according to information on the template provided by the template providing part to indicate that one or more contents regarding the one or more histories or the one or more goals have been inputted by the manager at one or more positions on the baseline or around the one or more positions, wherein the one or more positions are determined to correspond to the acquired one or more pieces of information on the start points of time or the end points of time.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram showing an overall configuration of a whole system with which information on an organization is recorded and managed in accordance with one example embodiment of the present invention.

FIG. 2 is a drawing illustrating an internal configuration of a server in details in accordance with one example embodiment of the present invention.

FIG. 3 is a drawing exemplarily explaining that one or more main areas for indicating existence of main information and one or more sub areas for indicating existence of subordinate information have been created and displayed through a template in accordance with one example embodiment of the present invention.

FIGS. 4 and 5 are diagrams exemplarily showing user interface by which contents regarding histories of the organization can be inputted in accordance with one example embodiment of the present invention.

FIG. 6 is a drawing exemplarily displaying main areas and sub areas.

FIG. 7 is a drawing exemplarily explaining a case of selecting one area among the main areas and the sub areas in accordance with one example embodiment of the present invention.

FIG. 8 is a drawing exemplarily explaining a screen on which a list of employees of the organization is displayed in accordance with one example embodiment of the present invention.

### DETAILED DESCRIPTION OF THE PREFERRED EMBODIMENTS

To make purposes, technical solutions, and advantages of the present invention clear, reference is made to the accompanying drawings that show, by way of illustration, more detailed example embodiments in which the invention may be practiced. These embodiments are described in sufficient detail to enable those skilled in the art to practice the invention.

It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Detailed explanation will be made by referring to the attached drawings with respect to the desirable example embodiments of the present invention to make those skilled in the art practice the invention.

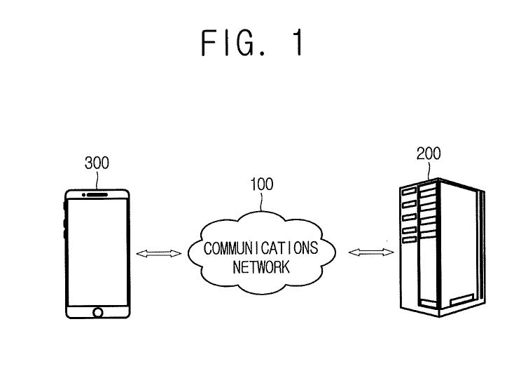

FIG. 1 is a diagram showing an overall configuration of a whole system with which information on an organization is recorded and managed in accordance with one example embodiment of the present invention.

As illustrated in FIG. 1, the whole system in accordance with one example embodiment of the present invention may be configured with a communications network, a user terminal, and a server.

First of all, a “user” in this specification may represent a person who receives a service provided by the server in accordance with the present invention. In detail, the “user” may include a manager corresponding to the organization, a staff member of the organization, or an individual person who receives a screen where one or more main areas for indicating existence of main information on a history(s) or a goal(s) of the organization and one or more sub areas for indicating existence of subordinate information thereon are displayed. Herein, the manager corresponding to the organization means a person set as a manager of the organization among people in the organization or as a manager in relation to the organization even though the person does not belong to the organization. The manager may refer to several persons.

In addition, an “organization” in this specification may include a company, its affiliate, or its department, a business gathering, a political gathering, a gathering for studying, a social gathering, or any other gathering.

First of all, the communications network 100 in accordance with one example embodiment of the present invention may be configured in a form of wired or wireless communications and may be configured with a variety of communications networks including a wide area network (WAN), a local area network (LAN), a telecommunication network, an artificial satellite communication network, etc. More preferably, the communications network 100 in the present invention may include wireless communications networks implemented by technologies such as IEEE 802.11, code division multiple access (CDMA), wideband code division multiple access (WCDMA), global system for mobile communications (GSM), and long term evolution (LTE). However, the communications network 100 may also include at least part of a publicly known wireless communication network or a publicly known telephone network without being limited only to these.

Next, the server 200 in accordance with one example embodiment of the present invention may perform a function of receiving information on the organization, e.g., one or more contents regarding one or more histories or one or more goals of the organization, from the user terminal 300 through the communications network, providing a baseline which includes information on an order of time series in the user terminal 300, and providing a template including unit areas through which one or more main areas for indicating existence of main information or one or more sub areas for indicating existence of subordinate information on the one or more histories or the one or more goals are displayed. Herein, it is meant that one or more main areas for indicating existence of main information are areas created when one or more new histories are additionally inputted differently from one or more existing basic histories of the organization, and one or more sub areas for indicating existence of subordinate information are areas created when detailed histories subordinate to one or more certain basic histories are additionally inputted.

The more detailed explanation on the configuration and functions of the server 200 in accordance with the present invention will be made below.

The user terminal 300 in accordance with one example embodiment of the present invention is a digital device that includes a function of accessing and communicating with a server and any digital devices including a desktop computer, a laptop computer, a workstation, a PDA, a webpad, a mobile phone, etc., which have memory means and processors with a calculation ability, may be adopted as the user terminal 300 in accordance with the present invention. In particular, the user terminal 300 may include a program for a browser to get interface for recording and managing information on the organization provided by the server 200.

The internal configuration and functions of components of the server will be looked at below.

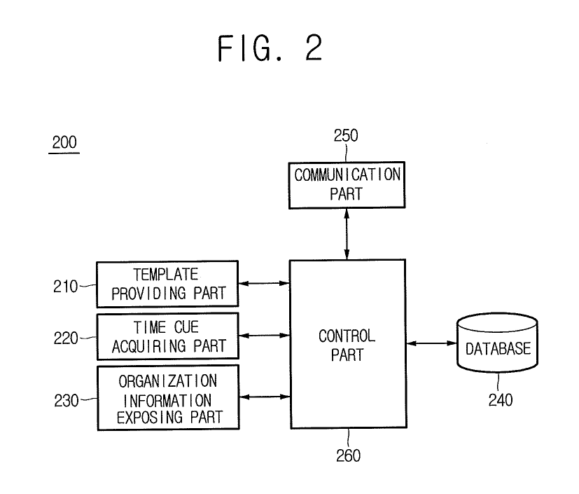

FIG. 2 is a drawing illustrating an internal configuration of the server 200 in details in accordance with one example embodiment of the present invention.

As illustrated in FIG. 2, the server 200 in accordance with one example embodiment of the present invention may include a template providing part 210, a time cue acquiring part 220, an organization information exposing part 230, database 240, a communication part 250, and a control part 260 where all of the template providing part 210, the time cue acquiring part 220, the organization information exposing part 230, the database 240, the communication part 250, and the control part 260 are not necessary to be included in the server 200, and they could be located outside interoperating with the server 200. In accordance with one example embodiment of the present invention, the template providing part 210, the time cue acquiring part 220, the organization information exposing part 230, the database 240, the communication part 250, and the control part 260 may be program modules, at least some which communicate with the user terminal 300. Such program modules may be included in the server 200 in a form of an operating system, an application program module, or other program module, and may be stored physically in various memory devices. Besides, such a program module may be also stored in a remote memory device that can communicate with the user terminal 300. Such a program module includes a routine, a sub-routine, a program, an object, a component, a data structure, etc. that perform specific work to be explained later or execute a certain type of abstract data in accordance with the present invention, but it is not limited to this.

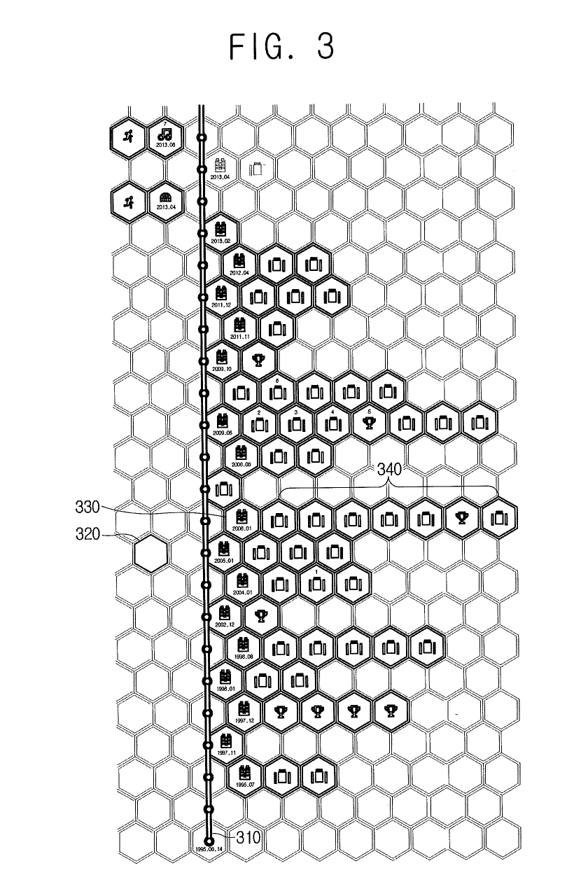

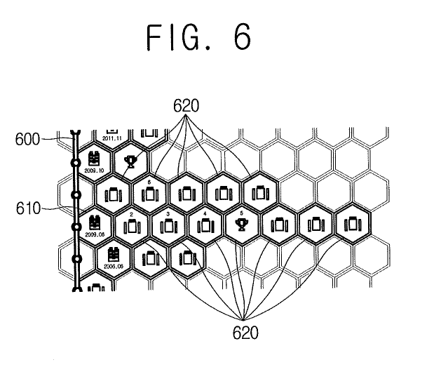

First of all, the template providing part 210 in accordance with one example embodiment of the present invention may allow a template where a baseline including a meaning of time series and unit areas (which are assumed to be hexagonal as shown in FIGS. 3 and 6) are indicated to be displayed through the user terminal 300. In another example, unit areas may not be visually displayed. In this specification, if a history(s) or a goal(s) of the organization is inputted, each of the unit areas may play a role as a basic frame where one or more main areas for indicating existence of main information or one or more sub areas for indicating existence of subordinate information are displayed to indicate that the history(s) or goal(s) of the organization has been inputted. Herein, the history(s) of the organization may include a task(s) performed by the organization, an award(s), an in-house club activity(s), a social contribution activity(s), etc.

While the one or more main areas for indicating existence of main information and the one or more sub areas for indicating existence of subordinate information are not created at all (i.e., while a history or a goal has not been inputted by the manager corresponding to a specific organization), the template providing part 210 may allow the baseline and lattice-shaped empty unit areas to be displayed at the same time. Whenever one or more histories or one or more goals of the organization are inputted, it may allow one or more main areas for indicating existence of main information or the one or more sub areas for indicating existence of subordinate information to be displayed through corresponding certain unit areas. Detailed explanation will be given below with respect to a case in which the one or more main areas or the one or more sub areas are displayed in the certain unit areas.

Meanwhile, the template providing part 210 may allow multiple unit areas to be displayed on a screen in a shape of lattice. For example, the respective unit areas may be hexagonal, and may be displayed with the respective unit areas being contacted with one another.

The template providing part 210 may provide the template including the baseline and multiple unit areas and further provide UI for allowing one or more contents capable of proving one or more corresponding histories or one or more corresponding goals in the respective main areas and the respective sub areas to be attached, and for allowing information on the histories or the goals of the organization to be inputted.

Next, if one or more new histories or one or more new goals are inputted by the manager, the time cue acquiring part 220 in accordance with one example embodiment of the present invention may perform a function of searching and acquiring one or more pieces of information on start points of time or end points of time regarding said one or more new histories or said one or more new goals inputted by the manager. The time information acquired by the time cue acquiring part 220 may be used to specify one or more appropriate unit areas among all the unit areas in the template. Herein, the one or more appropriate unit areas are locations where the respective main areas or the respective sub areas are displayed by the organization information exposing part 230, which will be explained later.

In this specification, a “start point of time” or an “end point of time” regarding a new history or a new goal may be related to a period when the new history is carried out. For example, if an inputted new history relates to a prescribed task performed by the organization, it could represent a time of the task being performed. In addition, if a new goal is inputted by a manager of the organization, the time information on the goal could represent a time of setting the goal or a time of achieving the goal.

Next, if one or more new histories or one or more new goals are inputted by the manager, the organization information exposing part 230 may perform a function of displaying the one or more main areas for indicating existence of main information on the new histories or the new goals. The organization information exposing part 230 may allow the one or more main areas for indicating existence of main information to be created and displayed at one or more positions on the baseline or around the one or more positions, wherein the one or more positions are determined to correspond to the one or more pieces of information on the start points of time or the end points of time acquired by the time cue acquiring part 220. Herein, if there are multiple main areas, the multiple main areas may be allowed to be placed and displayed by referring to time information of the baseline.

Besides, after a specific main area for indicating existence of main information on a specific history has been created, if one or more subordinate histories belonging to the specific history are inputted, the organization information exposing part 230 may further perform a function of displaying one or more sub areas for indicating existence of subordinate information to indicate that one or more contents of the subordinate histories near the specific main area.

For example, after a specific history that the organization conducted a task related to the “development of a smartphone application” was inputted and a specific main area for indicating existence of main information on the specific history has been created, if at least one content of the developed application or an award(s) received during the performance of the task related to the “development of the smartphone application” by the organization is inputted as a subordinate history belonging to the specific history, at least one sub area for indicating existence of subordinate information may be allowed to be displayed around the specific main area (e.g., through at least one appropriate unit area located near a specific unit area where the specific main area is displayed). In addition, as explained below, the organization information exposing part 230 may also perform a function of displaying one or more main areas for indicating existence of main information and one or more sub areas for indicating existence of subordinate information in different colors depending on property categories of respective histories or property categories of sub-organizations belonging to the organization which perform one or more tasks relating to the respective histories.

Next, one or more contents of the one or more histories or the one or more goals of the organization inputted by the manager may be stored in the database 240 in accordance with one example embodiment of the present invention. In FIG. 2, it is illustrated that the database 240 is included in the server 200, but may be configured separately from the server 200, depending on the need of those skilled in the art who practice the present invention. Meanwhile, the database 240 in the present invention may be not only a narrow meaning of database as a concept that includes a computer-readable recording medium but also a wide meaning of database that includes data records based on a file system. Even a simple set of logs which can search and extract data may be the database 240 in the present invention.

In accordance with one example embodiment of the present invention, the communication part 250 may perform a function of transmitting and receiving data to/from the template providing part 210, the time cue acquiring part 220, the organization information exposing part 230, and the database 240 or perform a function of allowing the user terminal 300 and the server 200 to communicate with each other.

Lastly, the control part 260 in accordance with one example embodiment of the present invention may perform a function of controlling flow of data between the template providing part 210, the time cue acquiring part 220, the organization information exposing part 230, the database 240, and the communication part 250. In other words, the control part 260 in accordance with the present invention may control data flow from/to outside of the server 200 or among individual components of the server 200 to allow the template providing part 210, the time cue acquiring part 220, the organization information exposing part 230, the database 240, and the communication part 250 to perform their unique functions.

By referring to FIGS. 3 to 8, UI provided in accordance with one example embodiment of the present invention will be explained in more details below.

FIG. 3 is a drawing exemplarily explaining that the one or more main areas for indicating existence of main information and the one or more sub areas for indicating existence of subordinate information are located on a template in accordance with one example embodiment of the present invention.

By referring to FIG. 3, a baseline which has a meaning of time series is marked with reference no. 310, but it would not be necessary to be a straight line. In FIG. 3, the lowest part of the baseline 310 refers to the date of establishment or creation of the organization and as a point on the baseline 310 becomes closer to the highest part of the baseline 310, a point of time becomes closer to the present time. Besides, if a history or a goal at a specified time is inputted, a main area 330 for indicating existence of main information or sub areas 340 for indicating existence of subordinate information could be displayed through unit areas near a position corresponding to the specified time on the baseline 310. Herein, reference no. 320 means a hexagonal unit area included in a template and the main area 330 for indicating existence of main information is an area displayed through a unit area located closest to the baseline 310. The main area could correspond to an area that adheres to the baseline 310 or also an area that adheres to a hexagon half cut by the baseline 310. Besides, unit areas directly or indirectly adhere to the main area 330 for indicating existence of main information would be sub areas 340 for indicating existence of subordinate information.

By referring to FIG. 3 again, the template displayed in the user terminal may include the baseline 310 and the multiple unit areas 320. Before information on the history(s) or the goal(s) of the organization is inputted, the baseline 310 and only the multiple unit areas 320 that have visual effects of showing their inner parts to be empty may be displayed. As the case may be, the unit areas 320 may not be displayed on a screen. If a new history or a new goal is inputted or one or more contents of one or more subordinate histories, i.e., one or more detailed histories, corresponding to the already created main area for indicating existence of main information are inputted, the main area 330 for indicating existence of main information or the one or more sub areas 340 for indicating existence of subordinate information may be created and displayed through unit areas at proper positions among the unit areas whose inner parts have been empty.

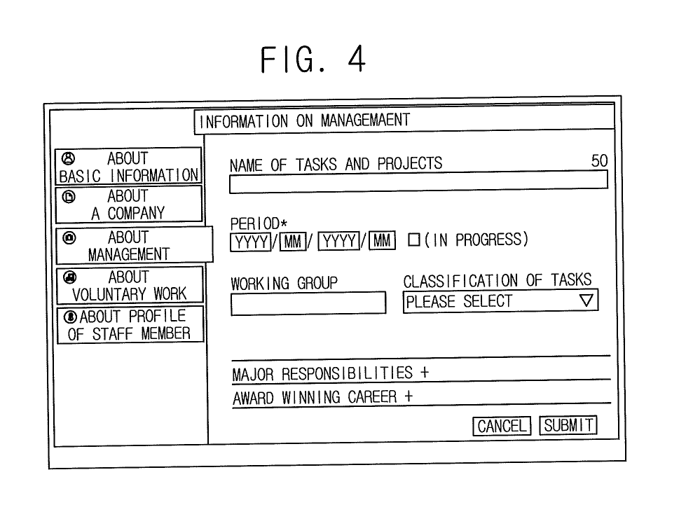

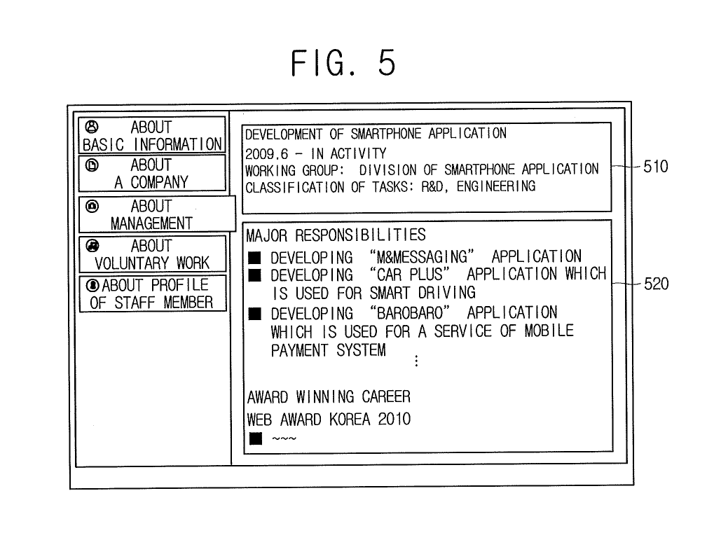

More specifically, if a specific history or a specific goal is inputted by the organization, the main area 330 for indicating existence of main information on the specific history or the specific goal may be displayed through a certain unit area determined by referring to the information on start points of time or end points of time acquired by the time cue acquiring part 220. If multiple main areas for indicating existence of main information are necessary to be placed, the multiple main areas for indicating existence of main information may be displayed at positions which are determined to correspond to both information on the start points of time or the end points of time of histories or goals corresponding thereto and the time information of the baseline. Accordingly, this allows the multiple main areas for indicating existence of main information to be displayed in serial order along a direction of the baseline. Herein, it could be assumed that texts, etc. regarding histories or goals of the organization may be inputted by the manager through UI such as shown in FIGS. 4 and 5 provided separately from another UI shown in FIG. 3 and as another example, it could be also brought up that a manager attempts to input histories or goals of the organization by directly selecting (e.g., by mouse-clicking) a certain unit area(s) among the multiple lattice-shaped unit areas on the screen where the UI as shown in FIG. 3 is provided. In the former, after the time cue acquiring part 220 analyzes texts inputted by the manager and then extracts information on start points of time or end points of time, the organization information exposing part 230 could display one or more main areas for indicating existence of main information or one or more sub areas for indicating existence of subordinate information through certain unit areas determined by referring to the extracted information. In the latter, because time information is granted to one or more certain unit areas, the organization information exposing part 230 could display the one or more main areas for indicating existence of main information or the one or more sub areas for indicating existence of subordinate information through the certain unit areas if the certain unit areas are selected by the manager. However, explanation will be made mainly based on the former in the specification.

If one or more new goals are inputted, an effect of visually indicating that the new goals have not been achieved yet is displayed in the main area for indicating existence of main information corresponding to the new goals. For example, in order to indicate that the one or more goals are now in progress, it would be possible to produce an effect of making the corresponding one or more main areas regularly blink. For reference, if the one or more main areas for the one or more goals are created, an authority to edit for k times may be granted but an authority to delete any created goals may not be granted to prevent the manager of the organization from deleting the goals after the goals have failed to be achieved.

The main area 330 for indicating existence of main information may be displayed with a visual effect different from those 330 which have different property categories of corresponding histories. As illustrated in FIG. 3, colors in the areas may be displayed differently depending on property categories of the histories or property categories of sub-organizations (e.g., departments) belonging to an organization (e.g., a company) that performed the tasks regarding the histories. In detail, as examples of property categories of the histories or property categories of sub-organizations belonging to the organization that performed the tasks regarding the histories, categories of management/strategy/planning, education, design, marketing, sales/marketing, laws/legal affairs, research/development/engineering, manufacturing, consulting, accounting/tax/finance, etc. could be assumed, but it is not limited thereto. As such, colors in the main area may be displayed differently according to information on property categories inputted by the manager.

It was explained that colors in the corresponding areas are displayed differently depending on property categories, but it could be thought that even colors outside of the corresponding areas, i.e., colors of boundary lines of the corresponding areas, are made to be different. More specifically, the color in the main area 330 for indicating existence of main information and that outside of the main area 330 could be allowed to be displayed differently depending on information on hierarchy among property categories of histories or sub-organizations of the organization. For example, when histories in one or more main areas for indicating existence of main information are related to a task(s), colors outside of one or more main areas for indicating existence of main information are determined by industrial group where the organization belongs and colors in the one or more main areas for indicating existence of main information could be allowed to be determined by referring to property categories of the sub-organizations which performed the task(s). Of course, a method for determining colors may be set differently, as the case may be.

To determine a unit area to expose the main area 330 for indicating existence of main information, information on a start point or an end point of time of the new history or the new goal as well as its property category may be referred to. More specifically, the main area 330 for indicating existence of main information may be displayed on one side or on the other side of the baseline 310 according to the property category of the new history or the new goal. For example, if one or more main tasks performed by the organization or one or more goals in relation thereto are inputted, they may be displayed on the right side of the baseline 310 as shown in FIG. 3. Contrarily, the main area 330 for indicating existence of main information on the history or the goal excluding the main tasks, e.g., the history or the goal related to social contribution activities of the organization, in-house club activities, etc., may be allowed to be displayed on the left side of the baseline 310 as shown in FIG. 3.

After the main area 330 for indicating existence of main information is displayed, if one or more subordinate histories with respect to a specific history recorded in the main area 330 are newly inputted, as illustrated in FIG. 3, the sub areas 340 for indicating existence of subordinate information may be displayed near the main area 330, i.e., through unit areas directly or indirectly adhering to the main area 330. Herein, an earlier inputted subordinate history among the subordinate histories could be allowed to be exposed in a unit area closer to the main area 330, but they are not limited to these. If subordinate histories are inputted in excess of the number of sub areas 340 capable of being displayed in one line, a new line immediately above or immediately below a current line on which the main area 330 is located is created. Accordingly, the sub areas 340 could be additionally displayed on the new line. At the time, it could be necessary to adjust time information of the baseline 310 due to the newly created line. As an another embodiment, it could be assumed that, even though the one or more subordinate histories belonging to the specific history have been inputted, the sub areas 340 may not be displayed immediately. For example, the sub areas 340 may be allowed to be displayed near the main area 330 just after the main area 330 is selected (e.g., just after an act of putting a mouse over, or mouse-clicking, the main area 330).

As explained above, as the sub areas 340 could be displayed on one side or on the other side of the baseline 310 depending on property categories of the histories in the main area 330, the sub areas 340, if it is necessary to expose them, may be displayed near the main area 330 and may be displayed on a same side of the baseline 310 as the main area 330.

The specific main area 330 with respect to a specific history and the sub areas 340 for indicating existence of subordinate information on the subordinate histories belonging to the specific history are set to have identical visual effects with each other by default and have different visual effects from other areas with different property categories. In accordance with one example embodiment of the present invention, a color in the specific main area and those in the sub areas may be displayed differently from those in the said other areas with the different property categories corresponding to the specific history or the different property categories of the sub-organizations of the organization that performed a specific task regarding the specific history. At this time, as explained above, depending on hierarchy among the property categories corresponding to the specific history or the property categories of the sub-organizations, the colors in the specific main area 330 and in the sub areas 340 and those outside of the specific main area 330 and the sub areas 340 may be displayed differently from those in the said other areas with the different property categories.

In accordance with one example embodiment of the present invention, the template providing part 210 may provide UI for allowing one or more contents to prove one or more corresponding histories in the main area 330 and the sub areas 340 to be attached. For example, if the organization performed a task related to a development of a smartphone application and inputs a history regarding the task, the history of the organization may be proved by attaching one or more contents such as a screen shot of the application produced by the organization, an article(s) regarding the application, or a video of a running state of the application through the UI.

At the time, one or more areas with any documentary evidence regarding any history may be displayed to show visual effects differently from the remaining main areas and the remaining sub areas. For example, as illustrated in FIG. 3, the remaining main areas or the remaining sub areas without any documentary evidence could be allowed to be displayed in grey color regardless of property categories.

FIGS. 4 and 5 are diagrams exemplarily showing user interface by which contents regarding the history of the organization can be inputted in accordance with one example embodiment of the present invention.

UI as illustrated in FIG. 4 may include areas through which the name(s) of the task(s) and project(s) performed by the organization, the period(s) of the task(s) and project(s), a sub-organization(s) (or a name of a department) that performed the task(s) and project(s), property category(s) of the sub-organization(s) (classification of tasks), results of main tasks, awards, etc. could be inputted. In FIG. 4, explanation was made on assumption that it is the UI for inputting a history regarding a task, but it is not limited to this and the UI for inputting a variety of kinds of histories (e.g., social contribution activities or in-house club activities) may be provided, as the case may be.

The time cue acquiring part 220 could acquire information on start points of time or end points of time regarding one or more histories from information on the period of the task and project among pieces of information inputted through the UI as shown in FIG. 4. Besides, the organization information exposing part 230 may determine which visual effects could be applied to each of the main areas and each of the sub areas by referring to information such as property categories of the sub-organization that performed the task and the project, etc. among pieces of information inputted through the UI as shown in FIG. 4. For example, the organization information exposing part 230 may determine colors of the respective main areas and the respective sub areas.

FIG. 5 is a drawing to explain that data related to the name(s) of the task(s) and project(s) performed by the organization, a period(s) of the task(s) and project(s), a sub-organization(s) (or a name of a department) that performed the task(s) and project(s), property category(s) of the sub-organization(s) (classification of tasks), results of main tasks, awards, etc. are inputted by the manager. If a specific history is inputted as illustrated in FIG. 5, a specific main area 610 for indicating existence of main information on the specific history and sub areas 620 for indicating existence of subordinate information may be created as illustrated in FIG. 6. (As stated above, if subordinate histories are inputted in excess of the number of sub areas capable of being displayed in one line, a new line can be created.)

By referring to FIGS. 5 and 6, if main information 510 on the specific history including the name(s) of the task(s) and project(s) performed by the organization, a period(s) of the task(s) and the project(s), a sub-organization(s) (or a name of a department) that performed the task(s) and project(s), property category(s) of the sub-organization(s) (classification of tasks), etc. is inputted, the main area 610 for indicating existence of main information may be created in a unit area which is located around a certain point on the baseline 600. Herein, a certain point is determined by referring to time information extracted from the main information 510. At the time, as the period of the specific history is from June 2009 to the present, the main area 610 may be created in the unit area located around the certain point which is corresponding to, e.g., a start point of time, i.e., June 2009. Results of main tasks and awards 520 in FIG. 5 may be subordinate histories of the specific history, and as illustrated in FIG. 6, the sub areas 620 may be created near the main area 610. At the time, as illustrated in FIG. 5, if the specific history is in progress to the present, an effect of visually indicating on the main area that the task corresponding to the specific history is still in progress may be displayed. For example, an effect of the main area blinking may be displayed.

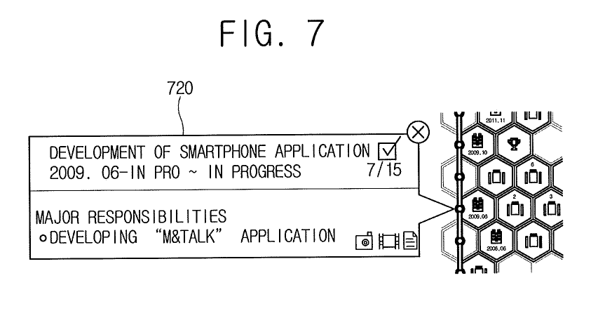

FIG. 7 is a drawing exemplarily explaining a case of selecting one area among the main areas and the sub areas in accordance with one example embodiment of the present invention.

As illustrated in FIG. 7, if a main area or a sub area displayed through a template is selected, a window 720 for providing detailed contents of a history or a goal recorded corresponding to the selected main area or the selected sub area may be displayed. For reference, multiple icon shapes are displayed on the right bottom in the window 720, and if the icons are selected, a screen where a photo(s), a video(s), a pdf document as well as a program(s) developed by staff members to prove the corresponding histories, etc. could be provided.

In accordance with one example embodiment of the present invention, the organization information exposing part 230 may display n pieces of histories or n pieces of goals selected among the one or more histories or the one or more goals inputted by the manager with visual signs to indicate that they are important histories or important goals. More specifically, one or more main areas and one or more sub areas selected to be important by the manager may show a regular blink effect. Additionally, detailed contents of the corresponding histories or goals may be allowed to show a visual effect of highlighting at least one important part in the detailed contents of the corresponding histories or goals on the displayed screen.

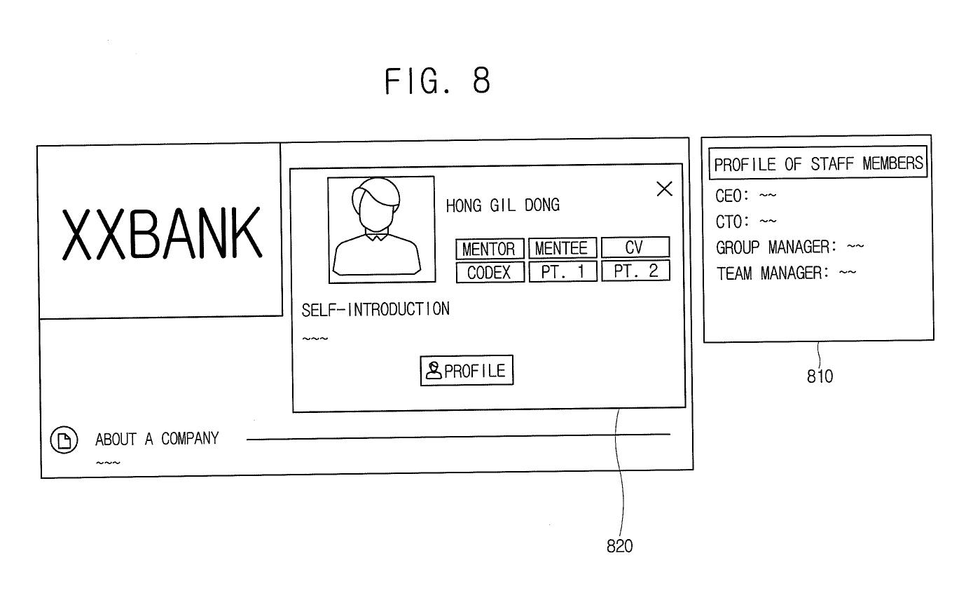

FIG. 8 is a drawing exemplarily explaining a screen of a list of employees of the organization being displayed in accordance with one example embodiment of the present invention.

In accordance with one example embodiment of the present invention, the organization information exposing part 230 may provide the screen of the list of employees of the organization. Herein, the screen of the list of employees of the organization may be separately provided from another screen where the baseline and the main area are displayed.

By referring to FIG. 8, the list of employees as shown in reference no. 810 may be displayed separately. If one employee is selected in the list of employees, the area 810 may be displayed with an area 820 where information on the selected employee is provided. When the list of employees is displayed, an employee as a member who has subscribed a service provided by the server in accordance with the present invention may be displayed by being distinguished from other employees who are not members and the information on the employee may be provided only to the members who have subscribed the service.

In accordance with the present invention, job seekers who want to apply for an organization, a person who wants to make a substantial analysis of the organization, and so forth may recognize history matters of the organization very easily and accurately by referring to the histories of the organization intuitively expressed on a template of a baseline including a meaning of time series and one or more main areas for indicating existence of main information, etc.

In accordance with the present invention, it may prevent the organization from laundering its image depending on its situation by depriving the manager of an authority to delete any created goals.

In accordance with the present invention, reliability on organization information may be improved by allowing contents capable of proving the histories or the goals regarding the organization to be attached.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled person in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present invention must not be confined to the explained embodiments, and the following patent claims as well as everything including variants equal or equivalent to the patent claims pertain to the category of the thought of the present invention.

1. A method for providing user interface to record and manage information on an organization, comprising steps of:
(a) providing a baseline including a meaning of time series;
(b) acquiring one or more pieces of information on start points of time or end points of time regarding one or more new histories or one or more new goals of the organization if the one or more new histories or the one or more new goals are inputted by a manager corresponding to the organization;
(c) displaying one or more main areas for indicating existence of main information to indicate that one or more contents related to the one or more histories or the one or more goals have been inputted at one or more positions on the baseline or around the one or more positions, wherein the one or more positions are determined to correspond to the acquired one or more pieces of information on the start points of time or the end points of time,
wherein the organization includes a plurality of members,
wherein personal histories or personal goals of the respective members are excluded from the histories or the goals of the organization, and
wherein the respective main areas for indicating existence of the main information are allowed to be displayed differently with visual effects corresponding to information on property categories of the respective histories or property categories of sub-organizations belonging to the organization which performed tasks regarding the histories.

2. The method of claim 1, comprising a step of:
(d) providing a detailed content of a specific history or a specific goal recorded corresponding to a specific main area which is selected among the displayed main areas for indicating existence of the main information.

3. (canceled)

4. The method of claim 1, wherein the respective main areas for indicating existence of the main information are allowed to be displayed in different colors depending on the information on the property categories of the respective histories or the property categories of the sub-organizations.

5. The method of claim 4, wherein colors in the respective main areas for indicating existence of the main information and those outside of the respective main areas for indicating existence of the main information are allowed to be displayed differently depending on information on hierarchy among the property categories of the respective histories or the property categories of the sub-organizations.

6. The method of claim 1, further comprising a step of:
(e) if one or more subordinate histories belonging to a specific history is inputted after a specific main area for indicating existence of main information on the specific history has been created, displaying one or more sub areas for indicating existence of subordinate information to indicate that one or more contents regarding the subordinate histories are inputted near the specific main area for indicating existence of the main information on the specific history.

7. The method of claim 6, wherein, at the step of (e), if the specific main area for indicating existence of the main information on the specific history is selected after the subordinate histories belonging to the specific history are inputted, the sub areas for indicating existence of subordinate information are displayed to indicate that the contents regarding the subordinate histories are inputted near the specific main area for indicating existence of the main information on the specific history.

8. The method of claim 6, wherein the specific main area for indicating existence of the main information on the specific history and the sub areas for indicating existence of subordinate information on the subordinate histories belonging to the specific history are set to have identical visual effects with each other by default and have different visual effects from other areas with different property categories of the specific history or a property category of a specific sub-organization belonging to the organization which performed a specific task regarding the specific history.

9. The method of claim 8, wherein a color in the specific main area for indicating existence of main information on the specific history and colors in the sub areas for indicating existence of subordinate information on the subordinate histories belonging to the specific history are displayed differently from those in the said other areas with the different property categories of the specific history or the different property category of the specific sub-organization.

10. The method of claim 9, wherein the colors in the specific main area for indicating existence of the main information on the specific history and in the sub areas for indicating existence of subordinate information on the subordinate histories belonging to the specific history and those outside of the specific main area for indicating existence of the main information on the specific history and the sub areas for indicating existence of subordinate information on the subordinate histories belonging to the specific history are displayed differently from those in the said other areas with the different property categories of the specific history or the different property category of the specific sub-organization.

11. The method of claim 8, wherein at least one area without any documentary evidence related to the specific history among the specific main area for indicating existence of the main information on the specific history and the sub areas for indicating existence of subordinate information on the subordinate histories belonging to the specific history are displayed to show visual effects differently from the remaining main areas and the remaining sub areas with any documentary evidence related to the specific history.

12. The method of claim 6, further comprising a step of:
(f) providing user interface for allowing one or more contents capable of proving one or more corresponding histories in the respective main areas for indicating existence of main information and the respective sub areas for indicating existence of subordinate information to be attached.

13. The method of claim 1, wherein n pieces of histories or n pieces of goals specially selected by the manager among the one or more histories or the one or more goals are displayed with visual signs to indicate that they are important histories or important goals.

14. The method of claim 13, wherein a corresponding main area for indicating existence of main information on the n pieces of histories or the n pieces of goals selected by the manager is displayed to regularly show a blink effect or an effect of highlighting at least one important part of detailed contents of the selected histories or the selected goals.

15. The method of claim 1, wherein one or more main areas for indicating existence of main information on main tasks of the organization and one or more goals related thereto are displayed on one side of the baseline, and one or more main areas for indicating existence of main information on one or more histories and one or more goals excluding the main tasks of the organization, and the one or more goals related thereto are displayed on the other side of the baseline.

16. The method of claim 15, wherein, after a specific main area for indicating existence of main information on a specific history has been created, if one or more subordinate histories regarding the specific history are inputted, one or more sub areas for indicating existence of subordinate information are displayed to indicate that one or more contents related to the subordinate histories are inputted near the specific main area for indicating existence of the main information on the specific history on the identical side of the baseline.

17. The method of claim 1, wherein a screen for providing user interface where one or more contents related to one or more histories of the organization are capable of being inputted is provided separately from a screen where the baseline and the main areas for indicating existence of main information on the one or more histories are displayed and one or more pieces of information on start points of time or end points of time regarding the one or more histories are acquired from one or more pieces of information inputted through the screen for providing the user interface.

18. The method of claim 1, wherein a screen for a list of employees of the organization is provided separately from another screen where the baseline and the one or more main areas for indicating existence of main information are displayed; and if one employee is selected in the list of employees, information corresponding to the selected employee is provided.

19. The method of claim 6, wherein, even if the one or more main areas for indicating existence of main information and the one or more sub areas for indicating existence of subordinate information do not exist at all, the baseline is displayed and, at the same time, lattice-shaped empty unit areas are displayed.

20. The method of claim 19, wherein the one or more main areas for indicating existence of main information and the one or more sub areas for indicating existence of subordinate information are displayed through one or more certain unit areas determined by referring to the start points of time or the end points of time regarding the one or more histories or the one or more goals corresponding to the created one or more main areas for indicating existence of the main information and the created one or more sub areas for indicating existence of subordinate information.

21. The method of claim 19, wherein the one or more main areas for indicating existence of the main information and the one or more sub areas for indicating existence of subordinate information are displayed through the one or more certain unit areas selected by the manager on the screen of the lattice-shaped unit areas.

22. The method of claim 19, wherein the respective unit areas are hexagonal, and are displayed in a shape of the respective unit areas close to each other.

23. The method of claim 1, wherein, if one or more new goals are inputted, an effect of visually indicating that the new goals have not been achieved yet is displayed in the main area for indicating existence of main information corresponding to the new goals.

24. The method of claim 1, wherein, if the history corresponding to the one or more main areas for indicating existence of the main information is in progress, an effect of visually indicating that the task regarding the history is still in progress is displayed.

25. The method of claim 1, wherein, if the one or more main areas for indicating existence of the main information on the one or more goals are created, an authority to edit for k times is granted but an authority to delete is not granted.

26. A server for providing user interface to record and manage information on an organization to a user terminal, comprising:
a template providing part for providing a template for displaying a baseline including a meaning of time series and displaying one or more main areas for indicating existence of main information to indicate that one or more contents regarding one or more new histories or one or more new goals of the organization are inputted by a manager of or in relation to the organization, wherein the main areas are displayed by referring to the baseline;
a time cue acquiring part for acquiring one or more pieces of information on start points of time or end points of time regarding one or more new histories or one or more new goals of the organization inputted by the manager; and
an organization information exposing part for displaying the one or more main areas for indicating existence of main information according to information on the template provided by the template providing part to indicate that one or more contents regarding the one or more histories or the one or more goals have been inputted by the manager at one or more positions on the baseline or around the one or more positions, wherein the one or more positions are determined to correspond to the acquired one or more pieces of information on the start points of time or the end points of time,
wherein the organization includes a plurality of members,
wherein personal histories or personal goals of the respective members are excluded from the histories or the goals of the organization, and
wherein the respective main areas for indicating existence of the main information are allowed to be displayed differently with visual effects corresponding to information on property categories of the respective histories or property categories of sub-organizations belonging to the organization which performed tasks regarding the histories.

27. (canceled)

28. The server of claim 26, wherein colors of the respective main areas for indicating existence of the main information are displayed differently depending on the property categories of the respective histories or the property categories of the sub-organizations belonging to the organization that performed the tasks regarding the respective histories.

29. The server of claim 26, wherein the organization information exposing part allows main areas for indicating existence of the main information on main tasks of the organization and one or more goals related thereto to be displayed on one side and allows main areas for indicating existence of the main information on respective histories and goals excluding the main tasks of the organization and the one or more goals related thereto to be displayed on the other side.

30. The server of claim 26, wherein the organization information exposing part provides a screen for a list of employees of the organization separately from another screen where the baseline and the main areas for indicating existence of the main information are displayed, and provides information on one employee in the list of employees if the employee is selected.

31. The server of claim 26, wherein, if one or more subordinate histories belonging to a specific history are inputted after a specific main area for indicating existence of main information for the specific history has been created, the organization information exposing part displays one or more sub areas for indicating existence of subordinate information to indicate that one or more contents regarding the subordinate histories have been inputted near the specific main area for indicating existence of the main information on the specific history.

32. The server of claim 31, wherein, even if the one or more main areas for indicating existence of main information and the one or more sub areas for indicating existence of subordinate information do not exist at all, the template providing part allows the baseline and lattice-shaped empty unit areas to be displayed at the same time.

33. (canceled)
